(19) United States
(12) Patent Application Publication
(10) Pub. No.: US 2025/0055081 A1
(43) Pub. Date: Feb. 13, 2025

(54) LAMINATED BATTERY

(71) Applicant: TOYOTA JIDOSHA KABUSHIKI KAISHA, Toyota-shi (JP)

(72) Inventors: Kenichi KAKISHITA, Nagoya-shi (JP); Yusuke IKEDA, Miyoshi-shi (JP); Tomofumi HIRUKAWA, Miyoshi-shi (JP); Masashi UEDA, Toyota-shi (JP); Shinji KOJIMA, Nagoya-shi (JP); Masataka OGUSHI, Nisshin-shi (JP); Kosuke YONEKAWA, Nisshin-shi (JP)

(73) Assignee: TOYOTA JIDOSHA KABUSHIKI KAISHA, Toyota-shi (JP)

(21) Appl. No.: 18/660,707

(22) Filed: May 10, 2024

(30) Foreign Application Priority Data
Aug. 9, 2023 (JP) 2023-130506

(51) Int. Cl. H01M 50/105

(52) U.S. Cl. CPC H01M 50/105; H01M 2220/20

(57) ABSTRACT

A laminated battery, a battery element, and a laminate film enclosing the battery element, wherein the laminate film has a fused portion in which end portions are overlapped and an inner surface is fused, and the laminate film has a fused portion side surface in which a fused portion is formed, an opposite side surface opposed to the fused portion side surface, and a pair of main surfaces orthogonal to the fused portion side surface and the opposite side surface and having an area larger than the fused portion side surface and the opposite side surface, and the laminate film has an uneven shape on at least one of the fused portion side surface and the opposite side surface.

### CROSS-REFERENCE TO RELATED APPLICATION

This application claims priority to Japanese Patent Application No. 2023-130506 filed on Aug. 9, 2023, incorporated herein by reference in its entirety.

### BACKGROUND

### 1. Technical Field

The present disclosure relates to a laminated battery.

### 2. Description of Related Art

There has hitherto been studied a laminated battery in which a battery element such as an electrode body is covered with and sealed in a laminate film and which includes a fused portion at which the end portions of the laminate film are superposed on each other and the inner surfaces of the laminate film are fused.

For example, Japanese Unexamined Patent Application Publication No. 2006-49054 (JP 2006-49054 A) discloses a sheet material type battery in which both electrodes of a battery power generation element are drawn to the outside, the battery power generation element is sandwiched in a concave-convex plate material that is an inner member from the upper and lower sides, the entire battery is wrapped with a sheet material, end portions etc. of the seat material are hermetically joined and sealed by heat welding etc., the concave-convex plate material is a single-sided concave-convex plate that includes a concave-convex portion on a surface opposite to a surface that sandwiches the battery power generation element, the seat material also includes a concave-convex portion corresponding to the concave-convex portion of the concave-convex plate material, and the concave-convex portions are combined to form a convex portion and a concave portion on the upper and lower side surfaces of the sheet material type battery.

### SUMMARY

When forming a fused portion in which the end portions of the laminate film are superposed on each other and the inner surfaces of the laminate film are fused, the fused portion is formed by a method in which a battery element in the state of being covered with the laminate film is put into a decompressed space and the superposed end portions of the laminate film are heat-sealed in the decompressed state, in order to enhance the sealing property. When the laminated battery in which the fused portion has been formed is taken out of the decompressed space and released from the decompressed state, however, deflection may be caused on a fused portion side surface or an opposite side surface of the laminate film, and the structural efficiency of the battery may be reduced.

The present disclosure has been made in view of the above circumstances, and has an object to provide a laminated battery capable of enhancing the structural efficiency of the battery.

Means for addressing the above issue includes the following aspects.

<1>
A laminated battery including:
a battery element; and
a laminate film that covers and seals the battery element, in which:
the laminate film includes a fused portion at which end portions are superposed on each other and inner surfaces are fused;
the laminate film includes a fused portion side surface in which the fused portion is formed,
an opposite side surface that faces the fused portion side surface, and a pair of main surfaces that is orthogonal to the fused portion side surface and the opposite side surface and that is larger in area than the fused portion side surface and the opposite side surface; and
the laminate film includes a concave-convex shape in at least one of the fused portion side surface and the opposite side surface.
<2>
The laminated battery according to the above aspect <1>, in which the laminate film includes the concave-convex shape in the opposite side surface.
<3>
The laminated battery according to the above aspect <1> or <2>, in which the laminate film includes, in at least one of the fused portion side surface and the opposite side surface, the concave-convex shape in which a concave portion and a convex portion are repeated from one of the main surfaces toward the other one of the main surfaces.
<4>
The laminated battery according to any one of the above aspects <1> to <3>, in which the laminate film includes the concave-convex shape over an entire surface of at least one of the fused portion side surface and the opposite side surface.

According to the present disclosure, it is possible to provide a laminated battery capable of enhancing the structural efficiency of the battery.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic cross-sectional view illustrating a laminated battery according to an embodiment of the present disclosure;

FIG. 2 is a schematic cross-sectional view illustrating a conventional laminated battery;

FIG. 3 is a schematic plan view showing a main part of a vehicle;

FIG. 4 is a schematic perspective view of a battery module;

FIG. 5 is a plan view of the battery module with the top cover removed; and

FIG. 6 is a schematic view of a battery cell accommodated in a battery module as viewed from a thickness direction.

### DETAILED DESCRIPTION OF EMBODIMENTS

A laminated battery including:

A laminated battery according to an embodiment of the present disclosure includes a battery element and a laminate film enclosing the battery element. The laminate film has a fused portion in which the end portions are overlapped and the inner surface is fused, and the laminate film has a fused portion side surface in which the fused portion is formed, an opposite side surface opposed to the fused portion side surface, and a pair of main surfaces orthogonal to the fused portion side surface and the opposite side surface and having a larger area than the fused portion side surface and the opposite side surface. The laminate film has an uneven shape on at least one of the side surface and the opposite side surface of the fused portion.

Hereinafter, an embodiment of a laminated battery according to an embodiment of the present disclosure will be described with reference to the drawings. Each drawing shown below is schematically shown, and the size and shape of each part are appropriately exaggerated for easy understanding.

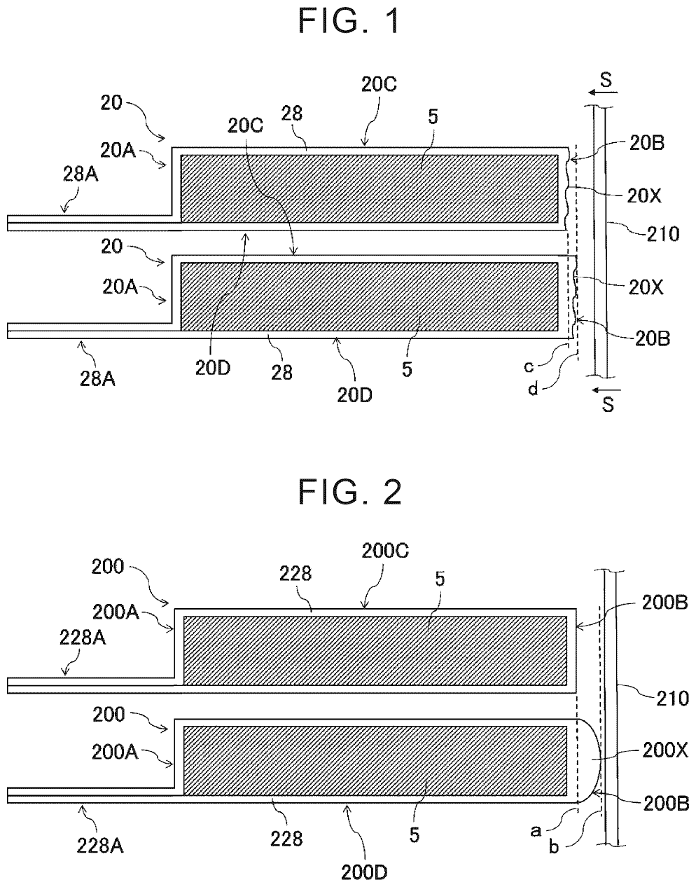

FIG. 1 is a schematic cross-sectional view illustrating a laminated battery according to an embodiment of the present disclosure. Incidentally, the upper portion of FIG. 1 represents a laminated battery before being released from the reduced pressure state when forming the fused portion in the laminate film. The lower portion of FIG. 1 represents the laminated battery after it has been released from the reduced pressure state when forming the fused portion in the laminate film.

The laminated battery 20 shown in FIG. 1 includes an electrode body 5 as an example of a battery element formed in a substantially rectangular plate shape, and a laminate film 28 that covers and encloses the electrode body 5. The laminate film 28 has a fused portion 28A in which end portions are superposed to each other and the inner surface is fused. The inner side of the laminate film 28 is sealed by the fused portion 28A. The laminate film 28 has four surfaces, i.e., a fused portion side surface 20A, an opposite side surface 20B, a pair of main surfaces 20C and 20D. The fused portion side surface 20A is disposed on the side where the fused portion 28A is formed. The opposite side surface 20B faces the fused portion side surface 20A. The pair of main surfaces 20C and 20D are perpendicular to the fused portion side surface 20A and the opposite side surface 20B, and have a larger area than the fused portion side surface 20A and the opposite side surface 20B. Note that the main surfaces 20C and 20D are surfaces that are in a stacking direction when a plurality of laminated batteries 20 are further stacked to form a battery stack. The laminate film 28 has an uneven 20X on the opposite side surface 20B.

In the laminated battery according to the embodiment of the present disclosure, since the laminate film has an uneven shape on the opposite side surface, the structural efficiency of the battery can be increased.

Here, a method for forming a fused portion on a laminate film in a conventional laminated battery will be described with reference to FIG. 2. FIG. 2 is a schematic cross-sectional view illustrating a conventional laminated battery, wherein the upper portion of FIG. 2 represents the laminated battery prior to being released from a reduced pressure state when forming a fusion bond in the laminate film. The lower portion of FIG. 2 represents the laminated battery after it has been released from the reduced pressure state when forming the fused portion in the laminate film.

The laminated battery 200 illustrated in the upper portion of FIG. 2 includes an electrode body 5 formed in a substantially rectangular plate shape, and a laminate film 228 that covers and encloses the electrode body 5. The laminate film 228 has a fused portion 228A in which end portions are superposed to each other and an inner surface is fused. The laminate film 28 has four surfaces: a fused portion side surface 200A, an opposite side surface 200B, a pair of main surfaces 200C, and a 200D. The fused portion side surface 200A is disposed on the side where the fused portion 228A is formed. The opposite side surface 200B faces the fused portion side 200A. The pair of main surfaces 200C and 200D are perpendicular to the fused portion side surface 200A and the opposite side surface 200B, and have a larger area than the fused portion side surface 200A and the opposite side surface 200B. Note that the 15 laminate film 228 does not have any concave-convex shapes on both the fused portion side surface 200A and the opposite side surface 200B.

In the laminated battery 200, when the fused portion 228A is formed on the laminate film 228, the electrode body 5 is first covered with the laminate film 228, and the end portions of the laminate film 228 are overlapped with each other. Next, the electrode body 5 and the laminate film 228 are placed in a reduced-pressure space, and the end portions of the laminate film 228 are thermally fused to each other under reduced pressure to form a fused portion 228A. Since the electrode body 5 generally has a dimensional difference for each individual, the laminate film 228 is usually dimensioned to have a margin with respect to the size of the electrode body 5. Therefore, the sealing property between the laminate film 228 and the electrode body 5 can be enhanced by performing thermal fusion bonding to the laminate film 228 in a state of being disposed in the decompression space as described above. However, when the laminated battery 200 after forming the fused portion 228A is taken out from the decompressed space and released from the decompressed state, a pressure differential occurs between the inside and the outside of the laminate film 228, and 200X of deflection of the laminate film 228 may occur on the opposite side surface 200B. When the deflection 200X occurred, the opposite side 200B of the laminate film 228 became curved as shown in FIG. 2, so that the position of the end portion of the opposite side 200B may extend from the position a to the position b. When the conventional laminated battery 200 is used, it is assumed in advance that a deflection 200X occurs on the opposite side surface 200B of the laminate film 228 to form a curved surface, and the position of a wall 210 of the battery case accommodating the laminated battery 200 is designed to be outside the position b shown in FIG. 2. In other words, a deflection 200X is generated on the opposite side surface 200B of the laminate film 228 to form a curved surface. The deflection of the laminate film 228 may occur not only on the opposite side surface 200B but also on the fused portion side surface 200A.

In contrast, in the laminated battery according to the embodiment of the present disclosure, the laminate film has an uneven shape on at least one of the fused portion side surface and the opposite side surface. Therefore, the laminated battery after the fusion portion is formed is taken out from the decompression space and released from the decompressed state, and even when a pressure difference occurs between the inside and the outside of the laminate film, deflection of the laminate film on the opposite side surface and the fused portion side surface is suppressed. That is, the deflection to be generated has an uneven shape.

It is absorbed and becomes difficult to deflect.
Therefore, for example, as shown in FIG. 1, the position of the end portion of the opposite side surface 20B after being released from the decompressed state can be suppressed to the extent that the end portion extends from the position c to the position d as compared with the conventional laminated batteries shown in FIG. 2. Thus, for example, the position of the wall 210 of the battery case accommodating the laminated battery 20 can be shifted in the direction of the arrow S as compared with the case of accommodating the conventional laminated battery illustrated in FIG. 2. Structural efficiency of the battery can be increased.

As described above, according to the laminated battery of the embodiment of the present disclosure, it is possible to increase the structural efficiency of the battery.

In FIG. 1, an aspect in which the laminate film 28 has an uneven 20X on the opposite side surface 20B (the surface facing the fused portion side surface 20A) is illustrated, but the laminated battery according to the embodiment is not limited thereto. That is, it may have an uneven shape on the fused portion side surface 20A in FIG. 1, or it may have an uneven shape on both the fused portion side surface 20A and the opposite side surface 20B. Although the deflection in the laminate film may occur on the fused portion side surface, the occurrence of the deflection in the fused portion side surface is suppressed by having the uneven shape on the fused portion side surface 20A.

However, in the laminated battery according to the embodiment of the present disclosure, it is preferable that the laminated battery has an uneven shape at least on the opposite side surface of the laminate film, from the viewpoint that the structural efficiency of the battery is more easily increased.

In FIG. 1, an aspect of the laminate film 28 having an uneven shape in which the concave portion and the convex portion are repeated from one main surface 20C side toward the other main surface 20D side (that is, from the upper side to the lower side in FIG. 1) is illustrated, but the laminated battery according to the embodiment is not limited thereto. That is, the concave portion and the convex portion may have an uneven shape in which the concave portion and the convex portion are repeated in a direction perpendicular to the direction from the one main surface 20C side toward the other main surface 20D side (that is, the depth direction in FIG. 1).

However, it is preferable that the laminated battery according to the embodiment of the present disclosure has an uneven shape in which the concave portion and the convex portion are repeated from one main surface 20C side toward the other main surface 20D side (that is, from the upper side to the lower side in FIG. 1), from the viewpoint that the structural efficiency of the battery is more easily improved.

In FIG. 1, an aspect in which an uneven 20X is formed on the entire surface of the opposite side surface 20B is illustrated, but the laminated batteries according to the embodiments of the present disclosure are not limited thereto. That is, in the opposite side surface 20B of the laminate film 28, the uneven shapes may be formed only partially. For example, the laminate film 28 may have an uneven shape only in a region on the main surface 20C side on the opposite side surface 20B, or may have an uneven shape only in a region on the other main surface 20D side on the opposite side surface 20B. In addition, it is possible to have an uneven shape only in the middle region thereof (that is, the uneven shape is not formed in the region on the main surface 20C side and the region on the main surface 20D side). Further, even in the direction perpendicular to the direction from the one main surface 20C side toward the other main surface 20D side (that is, the depth direction in FIG. 1), the uneven shapes may be formed only partially.

Incidentally, the same applies when the laminate film has an uneven shape on the fused portion side surface, the fused portion side surface of the laminate film, the direction from one main surface 20C side toward the other main surface 20D side (that is, the vertical direction in FIG. 1) uneven shape may be formed only in part. Further, on the fused portion side surface of the laminate film, even in a direction perpendicular to the direction from the one main surface 20C side toward the other main surface 20D side (that is, the depth direction in FIG. 1), the uneven shapes may be formed only partially.

However, in the laminated battery according to the embodiment of the present disclosure, it is preferable that the laminate film has an uneven shape on at least one of the fused portion side surface and the opposite side surface, from the viewpoint that the structural efficiency of the battery is more easily increased.

In FIG. 1, an uneven shape having three convex portions and three concave portions on the opposite side surface 20B is shown, but the laminated battery according to the embodiment is not limited thereto. The uneven shape of the laminate film on at least one of the fused portion side surface and the opposite side surface may be a shape having at least one of a convex portion and a concave portion. Incidentally, from the viewpoint that the structural efficiency of the battery is easier to increase, the uneven shape formed on at least one of the fused portion side surface and the opposite side surface of the laminate film is preferably an uneven shape having three or more convex portions and concave portions, respectively. It is more preferable to have an uneven shape having five or more protrusions and recesses, respectively. It is further preferable to have an uneven shape having ten or more protrusions and recesses, respectively. The upper limit of the number of the convex portions and the concave portions is not particularly limited, but may be, for example, an uneven shape having 30 or less convex portions and concave portions, respectively.

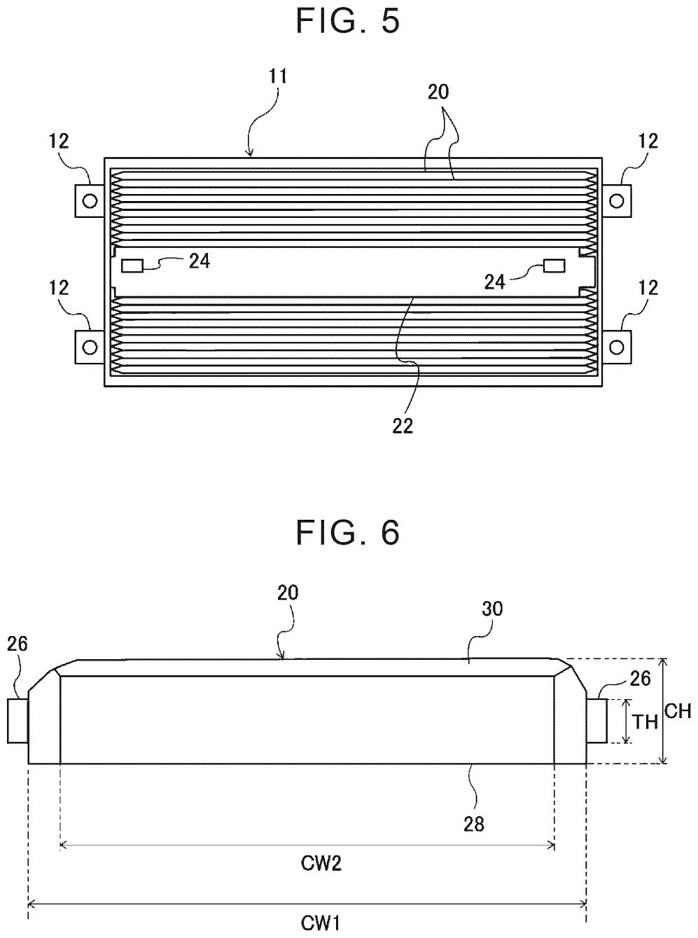

Next, a battery module, a battery pack, and a vehicle having a laminated battery according to an embodiment of the present disclosure will be described with reference to the drawings. Note that the laminated battery according to the embodiment of the present disclosure is used as the battery cell described in FIGS. 5 and 6 below. Entire structure of the vehicle 100

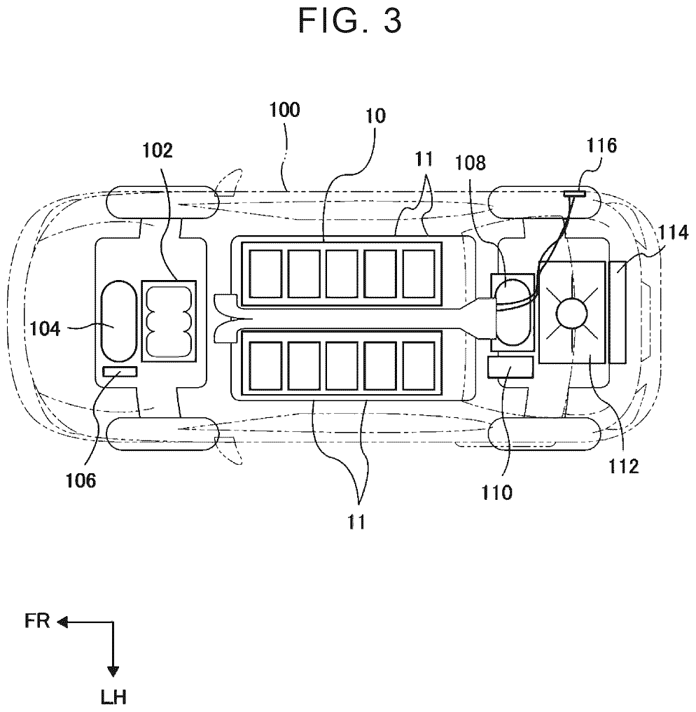

FIG. 3 is a schematic plan view showing a main part of a vehicle 100 to which the battery pack 10 according to the embodiment is applied. As illustrated in FIG. 3, the vehicle 100 is a Battery Electric Vehicle (BEV) in which the battery pack 10 is mounted under the floor. Note that the arrows UP, the arrow FR, and the arrow LH in the drawings respectively indicate the upper side in the vehicle up-down direction, the front side in the vehicle front-rear direction, and the left side in the vehicle widthwise direction. In the case where the description is made using the front, rear, left, right, and up and down directions, the front and back directions in the vehicle front-rear direction, the left and right directions in the vehicle width direction, and the up and down directions in the vehicle vertical direction are shown unless otherwise specified.

In the vehicle 100 of the present embodiment, DC/DC converters 102, the electric compressor 104, and Positive Temperature Coefficient (PTC) heaters 106 are arranged in front of the vehicle relative to the battery pack 10. Further, a motor 108, a gear box 110, an inverter 112, and a charger 114 are disposed on the vehicle rear side of the battery pack 10.

The DC current outputted from the battery pack 10 is regulated by DC/DC converters 102 and then supplied to the electric compressor 104, PTC heaters 106, the inverter 112, and the like. Further, electric power is supplied to the motor 108 via the inverter 112, so that the rear wheels rotate to drive the vehicle 100.

A charging port 116 is provided at a right side portion of a rear portion of the vehicle 100. When a charging plug of an external charging facility (not shown) is connected from the charging port 116, electric power can be stored in the battery pack 10 via the in-vehicle charger 114.

Note that the arrangement, structure, and the like of the components constituting the vehicle 100 are not limited to the above-described configurations. For example, it may be applied to an engine-mounted Hybrid Vehicle (HV) or Plug-in Hybrid Electric Vehicle (PHEV). Further, in the present embodiment, the motor 108 is a rear-wheel-driven vehicle mounted on the vehicle rear portion, but the present disclosure is not limited thereto, and the motor 108 may be a front-wheel-driven vehicle mounted on the vehicle front portion. A pair of motors 108 may be mounted in front of and behind the vehicle. Further, the vehicle may be provided with an in-wheel motor for each wheel.

Here, the battery pack 10 includes a plurality of battery modules 11. In the present embodiment, as an example, ten battery modules 11 are provided. Specifically, five battery modules 11 are arranged in the vehicle front-rear direction on the right side of the vehicle 100, and five battery modules 11 are arranged in the vehicle front-rear direction on the left side of the vehicle 100. The battery modules 11 are electrically connected to each other.

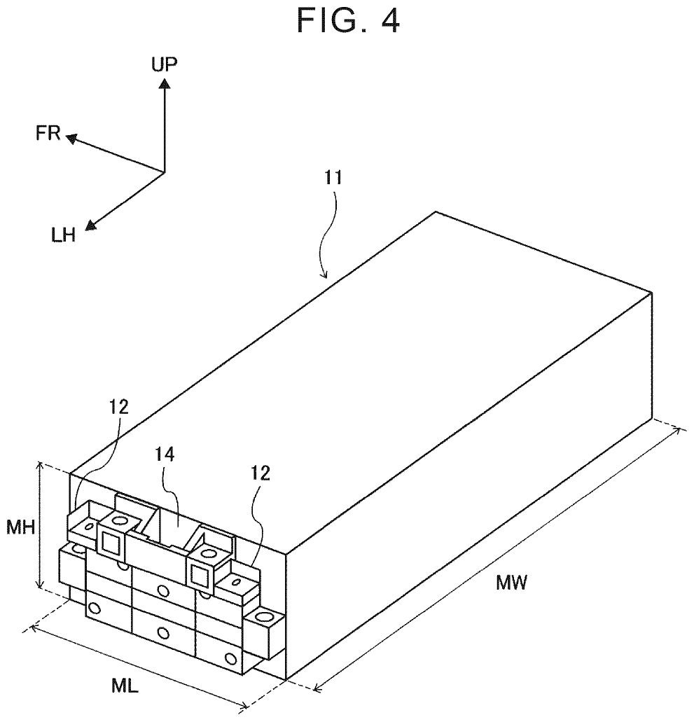

FIG. 4 is a schematic perspective view of the battery module 11. As shown in FIG. 4, the battery module 11 is formed in a substantially rectangular parallelepiped shape whose longitudinal direction is the vehicle width direction. The outer shell of the battery module 11 is made of an aluminum alloy. For example, an outer shell of the battery module 11 is formed by joining aluminum die-casting to both ends of an extruded material of an aluminum alloy by laser welding or the like.

A pair of voltage terminals 12 and a connector 14 are provided at both end portions of the battery module 11 in the vehicle width direction, respectively. A flexible printed circuit board 22, which will be described later, is connected to the connector 14. A bus bar (not shown) is welded to both end portions of the battery module 11 in the vehicle width direction.

The length MW of the battery module 11 in the vehicle width direction is, for example, 600 mm from 350 mm, the length ML in the vehicle front-rear direction is, for example, 250 mm from 150 mm, and the height MH in the vehicle vertical direction is, for example, 110 mm from 80 mm.

FIG. 5 is a plan view of the battery module 11 with the upper lid removed. As shown in FIG. 5, a plurality of battery cells 20 are accommodated in the battery module 11 in an arranged state. In the present embodiment, as an example, 24 battery cells 20 are arranged in the vehicle front-rear direction and adhered to each other.

A flexible printed circuit board Flexible Printed Circuit (FPC) 22 is disposed on the battery cell 20. The flexible printed circuit board 22 is formed in a band shape with the vehicle width direction as a longitudinal direction. Thermistors 24 are provided at both ends of the flexible printed circuit board 22. The thermistor 24 is not adhered to the battery cell 20 and is pressed toward the battery cell 20 by the upper lid of the battery module 11.

One or a plurality of cushioning materials (not shown) are accommodated in the battery module 11. For example, the cushioning material is an elastically deformable thin plate-shaped member, and is disposed between the adjacent battery cells 20 with the arrangement direction of the battery cells 20 as the thickness direction. In the present embodiment, as an example, cushioning materials are disposed at both end portions in the longitudinal direction of the battery module 11 and at a central portion in the longitudinal direction, respectively.

FIG. 6 is a schematic view of the battery cell 20 accommodated in the battery module 11 as viewed from the thickness direction. As shown in FIG. 6, the battery cell 20 is formed in a substantially rectangular plate shape, and an electrode body (not shown) is accommodated therein. The electrode body is formed by laminating a positive electrode, a negative electrode, and a separator, and is sealed with a laminate film 28.

In the present embodiment, as an example, the embossed sheet-like laminate film 28 is folded and bonded to form an accommodation portion of the electrode body. Although both of the single-cup embossing structure in which the embossing is performed at one place and the double-cup embossing structure in which the embossing is performed at two places can be adopted, in the present embodiment, the single-cup embossing structure has a 10 mm degree from the drawing depth 8 mm.

The upper ends of both end portions in the longitudinal direction of the battery cell 20 are bent, and the corners have an outer shape. Further, the upper end portion of the battery cell 20 is bent, and the fixing tape 30 is wound around the upper end portion of the battery cell 20 along the longitudinal direction.

Here, terminals (tabs) 26 are provided at both ends in the longitudinal direction of the battery cell 20. In the present embodiment, as an example, the terminal 26 is provided at a position offset downward from the center of the battery cell 20 in the vertical direction. The terminal 26 is joined to a bus bar (not shown) by laser welding or the like.

The vehicle-width-direction length CW1 of the battery cell 20 is, for example, 530 mm to 600 mm. The length CW2 of the area in which the electrode body is accommodated is, for example, from 500 mm to 520 mm. The height CH of the battery cell 20 is, for example, 80 mm to 110 mm. Further, the thickness of the battery cell 20 is from 7.0 mm to 9.0 mm, and the height TH of the terminal 26 is 40 mm to 50 mm.

What is claimed is:

1. A laminated battery comprising:
a battery element; and
a laminate film that covers and seals the battery element, wherein:
the laminate film includes a fused portion at which end portions are superposed on each other and inner surfaces are fused;
the laminate film includes a fused portion side surface in which the fused portion is formed, an opposite side surface that faces the fused portion side surface, and a pair of main surfaces that is orthogonal to the fused portion side surface and the opposite side surface and that is larger in area than the fused portion side surface and the opposite side surface; and
the laminate film includes a concave-convex shape in at least one of the fused portion side surface and the opposite side surface.

2. The laminated battery according to claim 1, wherein the laminate film includes the concave-convex shape in the opposite side surface.

3. The laminated battery according to claim 1, wherein the laminate film includes, in at least one of the fused portion side surface and the opposite side surface, the concave-convex shape in which a concave portion and a convex portion are repeated from one of the main surfaces toward the other one of the main surfaces.

4. The laminated battery according to claim 1, wherein the laminate film includes the concave-convex shape over an entire surface of at least one of the fused portion side surface and the opposite side surface.
